(19) United States
(12) Patent Application Publication
(10) Pub. No.: US 2009/0174348 A1
(43) Pub. Date: Jul. 9, 2009

(54) Motion controlled lamp

(76) Inventors: Mario A. Cugini, Vista, CA (US); Antonio Cugini, Vista, CA (US); Andrea Cugini, Vista, CA (US); Ralph Giusti, Vista, CA (US)

Correspondence Address: CALIF KIP TERVO, 6387 CAMINITO LAZARO, SAN DIEGO, CA, 92111, US

(21) Appl. No.: 12/006,909

(22) Filed: Jan. 7, 2008

(51) Int. Cl. H05B 37/00

(52) U.S. Cl. 315/312

(57) ABSTRACT

A light or lamp comprises a plurality of light sources, each said light source for emitting light of different color upon activation; and an electrical circuit connected to the light sources for alternately activating each light source responsive to successive accelerations, such as changes in direction of movement or vibrations, of the lamp by a user. A lamp for sports fans emits the team's colors successively with each movement such that a group of fans synchronously moving the lamps produce a field of similar color and movement.

### FIELD OF THE INVENTION

This invention relates in general to display lights or lamps, and more specifically involves a lamp for emitting light of different colors responsive to successive accelerations, including changes in direction of movement, or vibrations, of the lamp by a user.

### SUMMARY OF THE INVENTION

This invention is a lamp comprising a plurality of light sources, each light source for emitting light of different color upon activation; and an electrical circuit connected to the light sources for alternately activating each light source responsive to successive accelerations of the lamp by a user. The lights sources may be LEDs. A lamp with two different colors may be used to display colors of a sports team, music band, tactical team, cheerleading squad or other group.

A group of sports fans may synchronously move lamps to produce a field of emission of the same color and movement.

Other features and many attendant advantages of the invention will become more apparent upon a reading of the following detailed description together with the drawings wherein like reference numerals refer to like parts throughout.

### BRIEF DESCRIPTION OF THE DRAWINGS

FIG. 1 is a partial, perspective view of an exemplary embodiment of an LED version of the lamp of the invention.

FIG. 2 is a side elevation view of a user operating the lamp, 1^{st} motion.

FIG. 3 is a side elevation view of a user operating the lamp, 2^{nd} motion.

FIG. 4 is a diagram of an exemplary circuit for an LED version of a lamp with two colors.

### DETAILED DESCRIPTION OF THE INVENTION

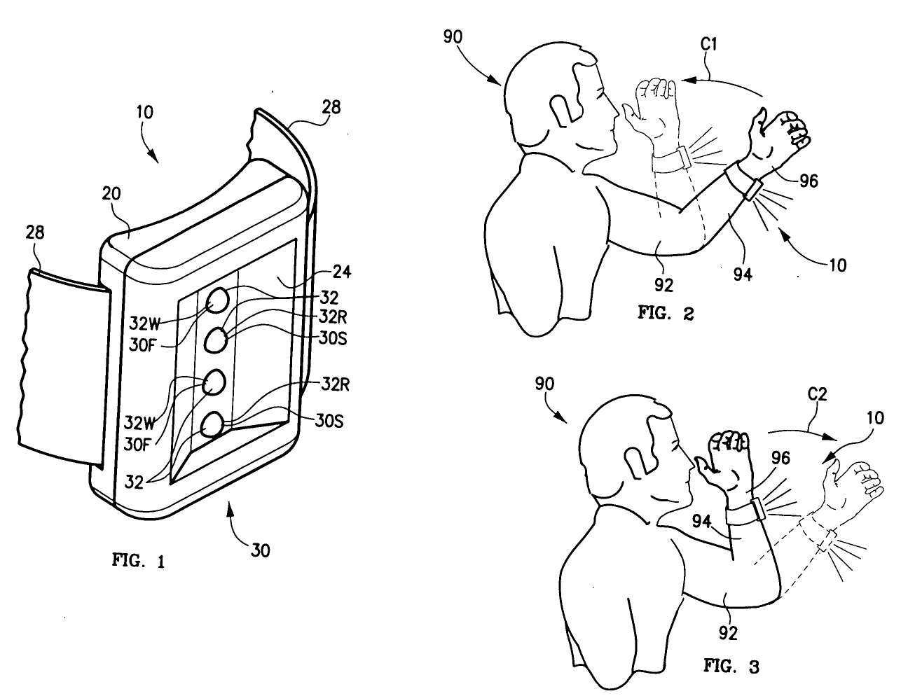

With reference now to the drawings, and more particularly to FIGS. 1-3 thereof, there is shown in FIG. 1 a partial, perspective view of an exemplary embodiment of a lamp 10 of the invention, in FIG. 2 a side elevation view of a user 90 operating the lamp 10 with a first motion, and in FIG. 3 a side elevation view of user 90 operating lamp 10 with a second motion.

Lamp 10 generally includes a housing 20 containing light sources 30, such as LEDs 32, of different colors. For example, a first light source 30F comprises the two LEDs 32, such as white LEDs 32W and a second light source 30S comprises the two LEDs 32, such as red LEDs 32R. LEDs 32 emit light upon activation. Preferably, LEDs 32 are sufficiently bright so as to be seen at a distance.

LEDs 32 may be exposed or may be placed behind a transparent window 24 in housing 20. Housing 20 may include attachment means, such as a resilient bracelet, or may be adapted to receive attachment means, such as a strap, such as wrist strap 28, shown cut away, for attaching lamp 10 to user 90, such as to user's wrist 96. Window 24 may be adapted, such as by frosting, to be a diffuser. Window 24 may be adapted, such as by ridges, to be a lens. Window may also be colored, with specific colors of a team or organization; while keeping the LEDs 32 below it, in white, or another base color, such that the color of the window is emitted. Alternately, each light source could comprise a plurality of different colored lights, such as red and blue LEDs, such that the emitted color is a blend, such as purple. Alternately, a colored filter could be used directly on the lamp.

Preferably, lamp 10 can be programmed to emit light in several desirable temporal patterns, one of which is shown in FIGS. 2 and 3. FIGS. 2 and 3 show a user 90 having lamp 10 attached to wrist 96 making cyclical front and back movements with a forearm 94. In FIG. 2 during movement C1, lamp 10 starts in the forward position wherein the first color is emitted and the first color continues to be emitted as lamp 10 is moved to the rear position. In FIG. 3 during movement C2, lamp 10 has just been stopped at the rear position wherein the first color is automatically turned off and the second color is emitted. The second color is emitted during forward movement of lamp 10 until movement is stopped wherein the first color is turned off and the second color is emitted thereby restarting the cycle. The same temporal behavior of the lights takes place by simply shaking the light in place, a new color is emitted as a result of every shake. For example, it works while the user is “clapping” their hands.
This example has many applications. For example, it may be used to send coded signals or a sports fan may alternately display the colors of the fan's team.

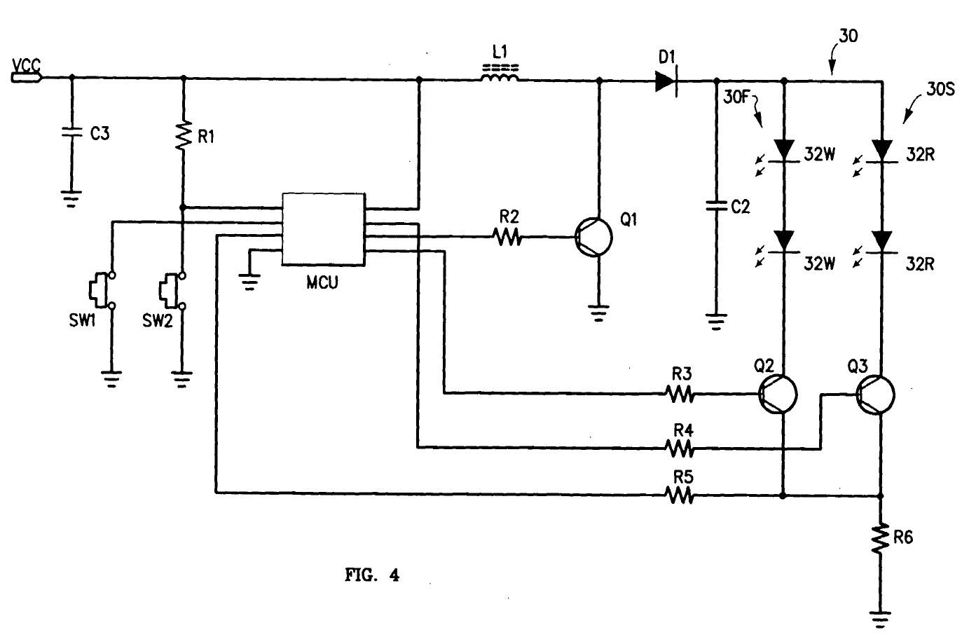

FIG. 4 is a diagram of an exemplary circuit 40 for lamp 10 of two colors. Circuit 40 in housing 20 is connected to LEDs 32W and 32R and alternately activating each light source 30F, 30S responsive to movement of lamp 10 by user 90. Circuit 40 is exemplary and is considered one of many circuits easily derived by someone reasonably skilled in the art to produce the claimed result.

In general, circuit 40 is a combination LED controller and switching regulator. It uses two switch inputs, first switch SW1 and second switch SW2, as inputs to a microcontroller unit (MCU) to control the operation of different color LEDs 32 as defined by software loaded into the microcontroller unit MCU to produce a desired lighting pattern largely responsive to acceleration of lamp 10, such as by changes of direction or motion, by user 90.

In exemplary circuit 40, an ATtiny 13V-10S18S2 AVR MCU manufactured by AMTEL is used as the microcontroller unit MCU. This low-voltage, low-power MCU includes an 8-bit microcontroller, EEPROM, SRAM, programmable flash memory and a timer. First switch SW1 is a push button switch. Second switch SW2 is a motion sensing switch, such as ONCQUE RB5070310, for detecting acceleration, such as changes in motion or direction or vibrations, of the lamp 10.

Current enters circuit 40 from an electrical power source VCC, such as batteries in housing 20, through the inductor L1. The current is directed by transistor Q1 either to capacitor C2 or to ground. When directed to ground, the current builds up energy in inductor L1, which in turn is transferred to capacitor C2 when transistor Q1 is not conducting. Diode D1 allows the current to only flow in the direction of capacitor C2. Timing of the current switching from ground to capacitor C2 is determined by the operation of the microcontroller unit MPU under direction of its software programming.

Transistor Q2 under direction from the microcontroller unit MPU enables current to flow through first color LEDs 30F. Likewise, transistor Q3 enables current through second color LEDs 32S.

The current from both transistor and LED networks is summed and passed through resistor R6. The voltage generated by this current is feed into an analog to digital converter in the microcontroller unit MPU to provide to the application software a measurement of current though the LEDs. This current measurement is used by the software and microcontroller unit MPU to set the timing duty cycle of the switching regulator to achieve a desired LED brightness, via current control.

Switches SW1 and SW2 provide control inputs to the microcontroller unit MPU to operate the desired function. Other resistors and capacitors are used in the normal manner obvious to anyone skilled in the art of electronics to properly operate the components to which they are associated.

Microcontroller unit MPU is easily programmed by someone of ordinary skill in the art of embedded software programming to provide the desired lighting functionality.

In a prototype of lamp 10, microcontroller unit MPU was programmed to function in three modes as follows. In the first mode, first switch SW1 is activated. The initial first switch SW1 signal to Microcontroller unit MPU activates white LEDs 32W. Acceleration of lamp 10, such as starting movement of lamp 10, is detected by second switch SW2. Second switch SW2 signal to Microcontroller unit MPU deactivates white LEDs 32W and activates red LEDs 32R. The next acceleration of lamp 10, such as by stopping movement, is detected by second switch SW2. Second switch SW2 signal to Microcontroller unit MPU deactivates red LEDs 32R and activates white LEDs 32W. In this mode, the duration of each color is determined by the time between accelerations of lamp 10.

The second mode of operation is entered by momentary depression of the first switch, SW1, a second time in a time window determined by the programming. In the second mode, white LEDs 32W are activated for a predetermined (programmable) short duration. Acceleration of lamp 10 activates red LEDs 32R. The next acceleration of lamp 10 de-activates red LEDs 32R and activates white LEDs 32W for a predetermined short duration after which red LEDs 32R are activated and the cycle repeats. In this mode, the first color is only on for a short period of time while the second color is on for any desired period of time between accelerations. In this manner, the second color may be emphasized.

The third mode of operation is entered by momentary depression of first switch, SW1, a third time in a time window determined by the programming. The third mode is opposite the second mode. In the mode, red LEDs 32R are activated for a predetermined short duration. Acceleration of lamp 10 activates white LEDs 32W. The next acceleration of lamp 10 de-activates white LEDs 32W and activates red LEDs 32R for a predetermined (programmed) short duration after which white LEDs 32W are activated and the cycle repeats. In this mode, the second color is only on for a short period of time while the first color is on for any desired period of time between accelerations. In this manner, the first color may be emphasized.

Although LEDs are shown as the light sources, other light emitting devices may be used. A light source may include a filter used to emit a light of a specific color. This allows the LEDs to remain white or some other base color while the light emitted from lamp 10 is a different color

Lamp 10 may have lights of more than two colors. Electrical circuitry for such a lamp 10 is easily derived by someone reasonably skilled in the art. For example, a three color light may be programmed to change color upon each acceleration, such as vibration or change in direction, of lamp 10 or may be programmed so that one or more of the colors is on for a predetermined time.

One application of lamp 10 is for use by a sports fan. For example, if the team's colors are red and white, the fan can flash one color upon one movement and the other color upon the return movement. A large group of fans may make synchronous movements to produce a large area of simultaneous emission of the same color and movement. It can also be implemented in the same manner at a concert or by marching bands or a cheerleading squad. It is believed many more applications will come to fore after the product is introduced to the marketplace.

Lamp 10 can be held in the user's hand, attached to the user in another location, such as to the user's head, or attached to another object manipulated by the user, such as to the user's hat, stick, such as a “thunder stick”, or other similar device.

Although a particular embodiment of the invention has been illustrated and described, various changes may be made in the form, composition, construction, and arrangement of the parts herein without sacrificing any of its advantages. Therefore, it is to be understood that all matter herein is to be interpreted as illustrative and not in any limiting sense, and it is intended to cover in the appended claims such modifications as come within the true spirit and scope of the invention.

I claim:

1. A lamp comprising:
a plurality of light sources, each said light source for emitting light of different color upon activation; and
an electrical circuit connected to said light sources for alternately activating each said light source responsive to successive accelerations of said lamp by a user.

2. The lamp of claim 1 wherein:
the accelerations are purposeful changes of motion of said lamp by a user.

3. The lamp of claim 1 wherein:
said electrical circuit includes:
a motion detection switch.

4. The lamp of claim 1 wherein:
the tempo of light changes is governed by the temp of the user's motions.

5. A lamp comprising:
a first light source for emitting light of a first color upon activation;
a second light source for emitting light of a second color upon activation; and
an electrical circuit connected to said first light source and said second light source for alternately activating said first light source or said second light source responsive to successive accelerations of said lamp by a user.

6. The lamp of claim 5 wherein:
the accelerations are purposeful changes of motion of said lamp by a user.

7. The lamp of claim 5 wherein:
said electrical circuit includes:
a motion detection switch.

8. The lamp of claim 5 wherein:
the tempo of light changes is governed by the temp of the user's motions.

9. A method of display comprising the step of:
positioning a plurality of persons in proximity; each person having a lamp comprising: a plurality of light sources, each light source for emitting light of different color upon activation; and an electrical circuit connected to the light sources for alternately activating each light source responsive to successive accelerations of the lamp by the person; such that synchronous movement of the lamps by the persons produce a field of emission of the same color and movement.
